(19) United States
(12) Patent Application Publication
(10) Pub. No.: US 2025/0345816 A1
(43) Pub. Date: Nov. 13, 2025

(54) ILLUMINATED PRESSURE WASHER GUN WITH ILLUMINATED SPRAY

(71) Applicant: TODD PERKINS, Pasco, WA (US)

(72) Inventor: TODD PERKINS, Pasco, WA (US)

(21) Appl. No.: 19/202,914

(22) Filed: May 8, 2025

Related U.S. Application Data
(60) Provisional application No. 63/644,038, filed on May 8, 2024.

(51) Int. Cl. B05B 9/01

(52) U.S. Cl. CPC B05B 9/01

(57) ABSTRACT

An illuminated pressure washer gun with illuminated spray generally provides a handle that has a hand grip portion and a trigger. A conduit for pressurized fluid is defined in the handle, and a pressure valve that is actuated by movement of the trigger regulates flow of pressurized fluid through the conduit which is received from a pressurized fluid source. A power source within the handle provides electrical energy to a plurality of light emitters carried within the handle, and the light emitters are positioned to illuminate the stream of pressurized fluid dispersed from the pressure wash gun.

### CROSS-REFERENCE TO RELATED APPLICATIONS

This US Non-provisional Utility Patent Application claims the benefit of priority to earlier filed U.S. Provisional Patent Application No. 63/644,038, which was filed on May 8, 2024 and titled ILLUMINATED PRESSURE WASHER GUN WITH ILLUMINATED SPRAY. Pursuant to USPTO rules, this priority claim is also set forth in the Application Data Sheet (ADS) filed herewith. The entire contents of said earlier filed U.S. Provisional Patent Application No. 63/644,038 is expressly and entirely incorporated herein by this reference.

### FIELD OF INVENTION

This invention relates to dispensing pressurized fluids through an orifice defined in a nozzle. More particularly, this invention relates to pressure washers, such as those used in car washes, and for exterior cleaning. Even more particularly, this invention relates to pressure washers having “pistol-type” spray handles wherein the pressurized fluidic spray dispersed from the spray gun nozzle is illuminated with visible electromagnetic radiation.

### BACKGROUND OF THE INVENTION AND DESCRIPTION OF RELATED ART

Pressure washers are known and are used for a wide variety of functions in various locations to direct a stream/spray/volume of pressurized fluid, generally water, onto a desired surface to remove dirt, dust and debris, and also to remove growths such as moss, lichen and molds and stains and for generalized cleaning of the exterior surfaces. The fluid may be heated or not heated. In the fluid may in specific instances/situations, contain additives such as, but not limited to, detergents, solvents, polishes and waxes.

Pressure washers are typically comprised of a source of pressurized fluid (generally water) such as a pump, although a pump is not required. The pump may be electrically powered or powered by an internal combustion engine. In some instances, such as for commercial purposes, the fluid may be pressurized to a range of approximately 1000 psi to 5000 psi. In other instances, such as for home/residential uses, the pressure may be in the range of standard residential water pressures, in the range of approximately 35 psi to 95 psi. Pressure washers typically include a spray gun that may have an elongated lance, from which the pressurized fluid is dispensed through an orifice defined in a nozzle, as well as a length of flexible tubing/hose that operatively communicates between the source of pressurized fluid and the spray gun. The fluid is pressurized within the pump (or other pressure source). The pressurized fluid is conducted through the flexible tubing/hose to the spray gun. An operator dispenses the pressurized fluid through the spray gun and the nozzle by means of actuation of a squeeze trigger and interconnected valves.

One recognized drawback to known pressure washers is that they are “boring” and do not provide visual, or audible, or tactile appeal to the user.

My illuminated pressure washer gun with illuminated spray overcomes and resolves various of the aforementioned drawbacks to known pressure washers, and provides additional aesthetic appeal.

It is known to use spotlights with pressure washer guns to shine upon an impact point where the pressurized fluid exiting the spray gun impacts the object/item being washed so as to allow a user to visualize the precise location being washed. This is known to be helpful such as in situations where a user is attempting to pressure wash an object that is shaded or concealed or difficult to access, such as, but not limited to, the underside of a vehicle, or perhaps wheel wells of a vehicle.

What continues to be needed is a pressure washer that illuminates, in a variety of different and/or changing colors, the stream/spray/volume of pressurized fluid exiting the spray gun, and/or a body of the spray gun, and/or even a nozzle of the spray gun so that the entire stream/spray/volume is aesthetically appealing and visible to a user as well as bystanders. The enhanced appeal provides economic advantages to users of my new invention. It is also contemplated that sound/audio may also be generated and emitted to coincide with the visual activity of my invention. It is even still further contemplated that haptic feedback, also known as tactile feedback, which may be generated by a device such as, but not limited to an eccentric rotating mass, or a linear resident actuator, may be paired with my invention to further enhance the appeal, desirability, “coolness”, and functionality thereof.

My illuminated pressure washer gun with colored illuminated spray is an improvement over known pressure washers because it provides visual, audio and tactile appeal and aesthetics to what otherwise is a mundane and boring task.

Some or all of the drawbacks and problems explained above, and other drawbacks and problems known and not yet recognized, may be helped or solved by my invention shown and described herein. My invention may also be used to address other problems not set out herein or which become apparent later. The future may also bring to light unknown benefits that may, in the future, be appreciated from the novel invention shown and described herein.

My invention does not reside in any single one of the identified features individually, but rather in the synergistic combination of all of its structures, which give rise to the functions necessarily flowing therefrom as hereinafter specified and claimed.

### BRIEF SUMMARY OF THE INVENTION

An illuminated pressure washer gun with illuminated dispersed spray generally provides a handle 10, a nozzle 70 and an emitter 31, 74 of visual electromagnetic radiation (EMR) that illuminates the stream/spray/volume of pressurized fluid exiting the nozzle 70.

In providing such an invention, it is a principal aspect to provide a spray gun for dispersing pressurized fluid received from a pressurized fluid source. The spray gun comprising: a handle (10) having a hand grip portion (13), a trigger guard (15) spacedly adjacent the hand grip portion (13) and a movable trigger (17) between the hand grip portion (13) and the trigger guard (15); a power source (19) (which may be internal or remote); a fluid conduit (20, 28) carried within the handle (10); a pressure valve (27) carried within the handle (10) and the pressure valve (27) operatively communicates with both the fluid conduit (20, 28) and with the trigger (17); a nozzle (70) carried by the handle (10) and operatively communicating with the fluid conduit (20, 28); and an emitter of visible electromagnetic radiation (31, 74) operatively communicating with the power source (19) and with the trigger (17), and the emitter of visible electromagnetic radiation (31, 74) illuminates the pressurized fluid/spray/volume dispersed from the spray gun through the nozzle (70).

A further aspect of the present invention is an apparatus for dispersing pressurized fluid received from a pressurized fluid source, the apparatus comprising: a handle (10) having a hand grip portion (13), a trigger guard (15) spacedly adjacent the hand grip portion (13) and a movable trigger (17) between the hand grip portion (13) and a trigger guard (15); a power source (19); an emitter trigger switch (26) carried within the handle (10) and operably communicating with the trigger (17); a fluid conduit (20, 28) carried within the handle (10); a pressure valve (27) carried within the handle (10) and operatively communicating with the fluid conduit (20, 28), with the trigger (17) and with the pressurized fluid source; a nozzle (70) defining a fluid exit orifice (104) carried by the handle (10) and operatively communicating with the fluid conduit (20, 28); and an emitter of visible electromagnetic radiation (31, 74) operatively communicating with the power source (19) and with the emitter trigger switch (26), and the emitter of visible electromagnetic radiation (31, 74) illuminates the pressurized fluid dispersed through the fluid exit orifice (104) defined in the nozzle (70).

A further aspect of the present invention is an apparatus for dispensing pressurized fluid and further comprising: a control board (18) that operatively communicates with the power source (19), with the emitter trigger switch (26), and with the emitter of visible electromagnetic radiation (31, 74).

A further aspect of the present invention is an apparatus for dispensing pressurized fluid and further comprising: a plurality of spacedly arrayed openings (25) defined in the handle (10); and a plurality of emitters of visible electromagnetic radiation (31, 74) carried within the handle (10).

A further aspect of the present invention is an apparatus for dispensing pressurized fluid and further comprising: an emitter of visible electromagnetic radiation (31, 74) carried by the nozzle (70) and proximate to the fluid exit orifice (104) to illuminate the dispersed pressurized fluid.

A further aspect of the present invention is an apparatus for dispensing pressurized fluid and further comprising: a lance (50) having a first end portion (51) that engages with the handle (10), and a second end portion (52) that engages with the nozzle (70); and the lance (50) having a housing (53) that has an exterior surface (54) that defines plural spacedly arrayed openings (56) and the lance (50) defines an interior channel (55) extending between the first end portion (51) and the second end portion (52); and a pressurized fluid tube (59) is carried in the interior channel (55), and the pressurized fluid tube (59) communicates with the fluid conduit (20, 28) in the handle (10) and with the nozzle (70); and plural emitters of visible electromagnetic radiation (31, 74) are carried within the Interior channel (55) and the plural emitters of visible electromagnetic radiation (31, 74) operatively communicate with the power source (19) and with the emitter trigger switch (26).

A further aspect of the present invention is an apparatus for dispensing pressurized fluid wherein the control board (18) is programmed to cause the emitter of visible electromagnetic radiation (31, 74) to illuminate and de-illuminate in a predetermined sequence.

A further aspect of the present invention is an apparatus for dispensing pressurized fluid and further comprising: a sound/audio generator (121) that operatively communicates with the control board (18) and with the power source (19) to generate and emit a predetermined audio signal/sound in synchrony with the predetermined sequence of illumination/de-illumination of the plurality of emitters (31, 74) of visible electromagnetic radiation.

A further aspect of the present invention is an apparatus for dispensing pressurized fluid and further comprising: a haptic feedback generator (120) that operatively communicates with the control board (18) and with the power source (19) to generate and emit a predetermined haptic feedback in synchrony with the predetermined sequence of illumination/de-illumination of the plurality of emitters (31, 74) of visible electromagnetic radiation.

A further aspect of the present invention is an apparatus for dispensing pressurized fluid and wherein the plurality of emitters (31, 74) of visible electromagnetic radiation are LEDs, or are LED light strips, or are light tubes, or are fiber optics, or are spotlights, or are lasers,

A further aspect of the present invention is an apparatus for dispensing pressurized fluid and further comprising: a mirrored/reflective coating on an interior surface of the nozzle (70) proximate the fluid discharge orifice (104).

A further aspect of the present invention is an apparatus for dispensing pressurized fluid and further comprising: a mirrored/reflective coating on an interior surface of the interior channel (53) of the lance (50).

A further aspect of the present invention is an apparatus for dispensing pressurized fluid and further comprising: a mirrored/reflective coating on an interior surface of the handle (10).

A still further aspect of the present invention is a method for illuminating a stream of dispersed pressurized fluid, comprising the steps: providing a source of pressurized fluid; and providing a pressurized fluid tube (111) that communicates with the source of pressurized fluid; and providing a handle (10) and connecting the handle (10) to the pressurized fluid tube (111), the handle (10) having a hand grip portion (13), a trigger guard (15) spacedly adjacent the hand grip portion (13) and a movable trigger (17) between the hand grip portion (13) and a trigger guard (15); and providing a power source (19) and connecting the power source (19) to the handle (10); and providing an emitter trigger switch (26) within the handle (10) and operatively communicating with the trigger (17); and providing a fluid conduit (20, 28) within the handle (10); and providing a pressure valve (27) within the handle (10) and the pressure valve (27) operatively communicates with the fluid conduit (20, 28), with the trigger (17) and with the source of pressurized fluid; and providing a nozzle (70) that defines a fluid exit orifice (104) and connecting the nozzle 70 with the fluid conduit (20, 28); and providing an emitter of visible electromagnetic radiation (31, 74) that operatively communicates with the power source (19) and with the emitter trigger switch (26), and the emitter of visible electromagnetic radiation (31, 74) to illuminate the pressurized fluid dispersed through the fluid exit orifice (104) defined in the nozzle (70) when a user deflects the trigger (17); and providing a control board (18) within the handle (10) that operatively communicates with the power source (19) and with the emitter triggers switch (26), and wherein the control board (18) is programmable to cause the emitter (31, 74) of visible electromagnetic radiation to illuminate and de-illuminate in a predetermined sequence.

An even still further aspect of the present invention is a method for illuminating a stream of dispersed pressurized fluid, and further comprising the step: providing an elongated lance (50) that has a first end portion (51) and a spaced apart second end portion (52); and attaching the first end portion (51) of the lance (50) to the handle (10); and attaching the nozzle (70) to the second end portion (52) of the lance (50).

Other and further objects of my invention will appear from the following specification and accompanying drawings which form a part hereof. In carrying out the aspects of my invention, it is to be understood that its structures, features, and steps are susceptible to change in design, and arrangement, and order with only one preferred and practical embodiment of the best-known mode being illustrated in the accompanying drawings and specified as is required.

### BRIEF DESCRIPTIONS OF THE DRAWINGS

Specific forms, configurations, embodiments and/or diagrams relating to and helping to describe preferred versions of my invention are explained and characterized herein, often with reference to the accompanying drawings. The drawings and all features shown therein also serve as part of the disclosure of our invention, whether described in text or merely by graphical disclosure alone. Such drawings are briefly described below.

FIG. 1 is an orthographic side view, cross-section of my illuminated pressure washer gun with a lance and a nozzle showing the structural configuration of my invention and the internal components, and general orientation thereof.

FIG. 2 is an orthographic side view of my invention, similar to that of FIG. 1, but not a cross-section.

FIG. 3 is an orthographic side view, cross-section of my illuminated pressure washer gun, similar to that of FIG. 1, less the nozzle.

FIG. 4 is an orthographic front view cross section of the handle of my illuminated pressure wash gun of FIG. 1, showing a battery power source within an internal chamber defined in the handle.

FIG. 5 is an orthographic side view cross-section of the lance, showing the internal components thereof.

FIG. 6 is an orthographic side view of a second contemplated embodiment of the lance showing plural spacedly arrayed openings defined therein.

FIG. 7 is an orthographic side view cross-section of the second contemplated embodiment of the lance shown in FIG. 6, showing the nozzle, and showing EMR emitter light tubes within the lance.

FIG. 8 is an enlarged, orthographic cross-section of one version of a nozzle showing a mirrored/reflective surface, the spray tip, and a plurality of spacedly arrayed EMR emitters, as well as another contemplated location for a power source.

FIG. 9 is an enlarged front-end view of the nozzle of FIG. 8.

FIG. 10 is an orthographic side view of a stylized mockup of my invention with a lance and nozzle.

FIG. 11 is an orthographic side view of a stylized mockup of my invention, similar to that of FIG. 10 but with the nozzle connected directly to the handle and without the lance such as for, but not limited to, use with a residential water supply.

### DETAILED DESCRIPTION OF THE INVENTION

The readers of this document should understand that the embodiments described herein rely on terminology used in any section of this document and other terms readily apparent from the drawings and the language common therefore as may be known in a particular art and known or indicated or provided by dictionaries. Dictionaries were used in the preparation of this document. Widely known and used in the preparation hereof are Webster's Third New International Dictionary (@1993), The Oxford English Dictionary (Second Edition, @1989), The New Century Dictionary (@2001-2005) and the American Heritage Dictionary of the English Language (4^{th} Edition @2000) all of which are hereby incorporated by this reference for interpretation of terms used herein to more adequately or aptly describe various features, aspects and concepts shown or otherwise described herein.

This document is premised upon using one or more terms or features shown in one embodiment that may also apply to or be combined with other embodiments for similar structures, functions, features, and aspects of the invention. Wording used in the claims is also descriptive of the invention and the text of both claims and abstract are incorporated by reference into the description entirely,

My illuminated pressure washer gun with illuminated spray generally provides a handle 10, a lance 50, a nozzle 70 and an emitter 31, 74 of visible electromagnetic radiation (EMR). The emitter of visible EMR 31, 74 may be, but is not limited to, light emitting diodes (LEDs), LED light strips, light tubes, fiberoptics, spotlights, lasers and/or other known apparatus for emitting visible electromagnetic radiation (EMR) which may or may not be colored, or change in color.

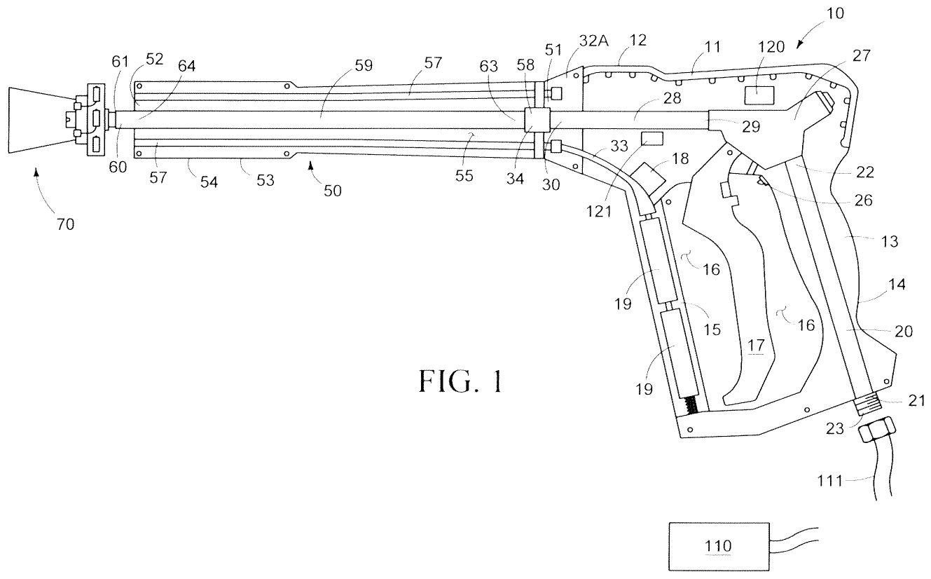

As shown in FIG. 1, the handle 10 has a body/housing 11 that has an exterior surface 12. The handle 10 is externally configured similar to a “hose-gun” nozzle, and defines at one edge portion a hand grip portion 13 that may define gripping undulations 14, and a trigger guard 15 spaced apart from, and opposite the hand grip portion 13. A trigger 17 is carried in a space defined between a rearward surface of the trigger guard 15, and a proximate edge surface of the gripping undulations 14 of the handle 10. The trigger 17 is movable, in the defined space, relative to the trigger guard 15 and relative to the gripping undulations 14 responsive to a user's “squeezing” of the trigger 17. An interior chamber 16 is defined within the body 11. The interior chamber 16 encloses a control board 18, a power source 19 such as, but not limited to a battery, and electrical wires 33 for operative circuitry. It is expressly contemplated the power source 19 may be internal to the handle 10, but it is also expressly contemplated the power source 19 may be remote from the handle 10, and operatively communicate with the handle 10 by means of conductors (wires, or the like) from a remote source. It is expressly contemplated the power source may be direct current (DC) such as may be provided by a battery, or also alternating current (AC) such as may be provided by an electrical outlet. It is further contemplated the flow of fluid through the handle 10 may provide the energy necessary to power my invention (e.g. a turbine that spends responsive to fluid flow).

A plurality of spacedly arrayed openings 25 are defined in the handle 10 exterior surface 12, and the plurality of spacedly arrayed openings 25 may communicate between the interior chamber 16 and the exterior surface 12. The interior chamber 16 may have a mirrored/reflective coating/surface.

The control board 18, is preferably a printed circuit board (PCB) and allows a user (or manufacturer/retailer) to program desired sequences for activation and deactivation of the emitters 31, 74 of visible EMR. Such desired sequences may be, but are not limited to, directional, timed, random, even responsive to identified cues/sounds/stimulus/movement. For example only, and without limitation, a programed sequence controlled by the control board 18 may cause one or more of the emitters 31, 74 of visible EMR to illuminate, for a pre-determined period of time, first in a hand grip portion 13 of the handle 10, and then sequentially illuminate additional ones of the plurality of emitters 31, 74 of visible EMR in sequence moving outward from the handle 10 toward the lance 50, and along the length of the lance 50, toward and to the nozzle 50; and also deactivating/de-illuminating/turning off the plurality of emitters 31, 74 of visible EMR after expiration of the pre-determined period of time, to create the optical representation of directional pulses.

It is also contemplated that an audio/sound generator 121 may generate and email it audio signals/sounds to accompany/pair with the programmed sequence of illumination/de-illumination of the emitters 31, 74 of visible EMR. It is further contemplated that a haptic feedback generator 120 (also known as “tactile feedback”) may be provided to accompany/pair with the programmed sequence of illumination/de-illumination of the plurality of emitters 31, 74 of visible EMR, and also to accompany/pair with the generated and emitted sound/audio.

A first fluid conduit 20 that has a first end portion 21, and a spaced apart second end portion 22, is enclosed within the handle 10, preferably within the portion of the handle 10 defining the hand grip portion 13. A hose fitting 23 (which may be releasable) is carried at the first end portion 21 of the first fluid conduit 20 so as to connect the first fluid conduit 22 to a flexible pressurized fluid hose 111 which operatively communicates with the source of pressurized fluid (not shown) such as, but not limited to, an electrically powered pump (Not shown) or residential water supply.

A pressure valve 27 is carried within the handle 10, and the pressure valve 27 and is operatively interconnected with the trigger 17 and with the first fluid conduit 20. Movement of the trigger 17, responsive to an operator squeezing/drawing the trigger 17 toward the hand grip portion 13 actuates the pressure valve 27. An operator squeezing the trigger 27 causes the pressure valve 27 to open, responsively allowing pressurized fluid to flow therethrough, while an operator releasing pressure on the trigger 27 causes the pressure valve 27 to close, responsively preventing the pressurized fluid from flowing therethrough. The pressure valve 27 is preferably biased to a closed position, the biasing is overcome when the trigger 17 is moved by an operator.

A second fluid conduit 28 operatively communicates with the pressure valve 27 opposite the first fluid conduit 20. The second fluid conduit 28 has a first end portion 29 that operatively communicates with the pressure valve 27, and a second end portion 30 that is spaced apart from the pressure valve 27. The second end portion 30 of the second fluid conduit 28 may contain a releasable connection 34, such as, but not limited to, a threaded connection, for interconnection to other components, such as a nozzle 70 or the lance 50. In one contemplated embodiment, the second fluid conduit 28 is not parallel to the first conduit 20. In other contemplated embodiments, the first and second fluid conduit's 20, 28 respectively, are parallel to one another.

An emitter trigger switch 26 is carried within the handle 10 and operatively communicates with the trigger 17. The LED trigger switch 26 electrically communicates with the control board 18, with the power source 19, and also communicates with at least one of the plurality of emitters 31, 74 of visible EMR.

In one contemplated embodiment, the emitters 31, 74 of visible EMR is an LED light strip 31 and is carried by the handle 10 within interior chamber 16 and/or on the exterior surface 12 of the handle 10. Light carrying/transmitting fiber-optic fibers, and/or light tubes may also be carried on/within the handle 10 to provide transmission of visible EMR at/to the desired location. The LED light strip 31, and/or plurality of LEDs 74, electrically/operatively communicate with the power source 19, the control board 18 and the emitter trigger switch 26 so that when the emitter trigger switch 26 is in an “on” position, such as, responsive to the user squeezing the trigger 17, electrical energy is passed by means of electrical wires 33 from the power source 19 through the emitter trigger switch 26 to the control board 18 to the plurality of emitters 31, 74 of visible EMR so as to cause the plurality of emitters 31, 74 of visible EMR to illuminate and emit a visible EMR on and about the handle 10. Further, the emitted visible EMR may pass outwardly from the interior chamber 16 through the plurality of spacedly arrayed openings 25 defined in the handle 10 to provide the desired aesthetic appeal. The light carrying/transmitting fiber-optic cables and/or light tubes and/or lenses (not shown) and/or prisms (not shown) may operatively interact with the plurality of emitters 31, 74 of visible EMR to pass/transmit/concentrate/focus the illumination as desired as well as to magnify/enhance/concentrate/condensed/focus the illumination.

In a further contemplated embodiment, a plurality of emitters 31, 74 of visible EMR, such as, but not limited to LEDs 74 are positioned immediately adjacent a fluid exit orifice 104 defined in a spray tip 75 carried at the second end portion 30 of the second fluid conduit 28 through which the pressurized fluid is dispersed.

In a still further contemplated embodiment, a spotlight LED may be carried within a housing flange 32A proximate the second end portion 30 of the second fluid conduit 28 so that when the spotlight LED is energized and illuminated, the illumination shines onto the pressurized fluidic spray being dispersed/sprayed from fluid exit orifice 104 defined in the spray tip 75 which causes the high-pressure fluidic spray to be illuminated.

In an even still further contemplated embodiment, a nozzle 70 is interconnected to the releasable connection 34 at the second end portion 30 of the second fluid conduit 28. The nozzle 70 may be configured similar to a truncated cone and define an interior surface 78. A plurality of emitters 31, 74 of visible EMR, such as, but not limited to, LEDs, or end portions of light tubes, are spacedly arrayed on/about the interior surface 78 to illuminate the spray/stream/volume exiting the spray tip 75. The interior surface 78 of the truncated cone is preferably made of, or coated with, a reflective coating such as, but not limited to, mirrored reflective film and/or similar materials, so that a greater percentage of the emitted visible electromagnetic radiation (EMR) emitted by the plurality of emitters 31, 74 of visible EMR is reflected and refracted on to the spray stream. In an even still further contemplated embodiment, prisms (not shown) and/or lenses (not shown) may be incorporated into/about the nozzle 70 and/or lance 50 and/or handle 10 to enhance concentration and/or focusing and/or reflection and/or refraction of the visible electromagnetic radiation (EMR) emitted from the plurality of emitters 31, 74 of visible EMR onto the spray stream and the handle 10, and the lance 50, and the nozzle 70.

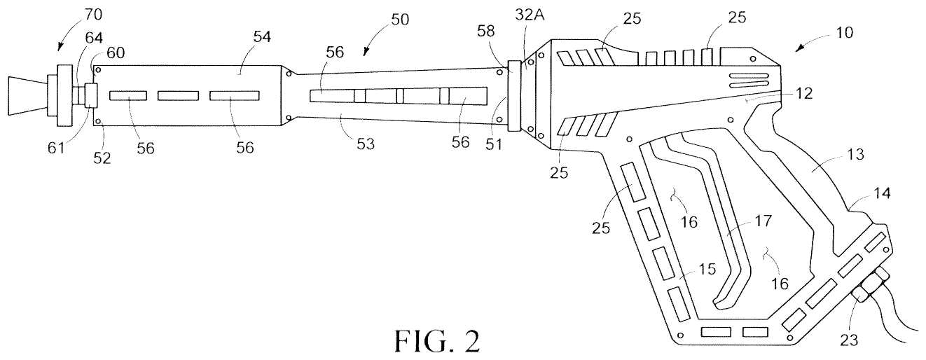

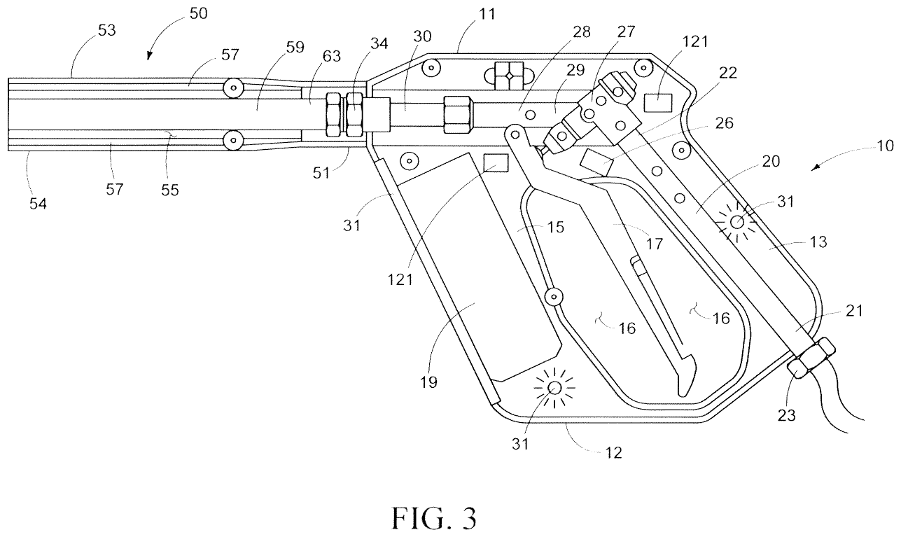

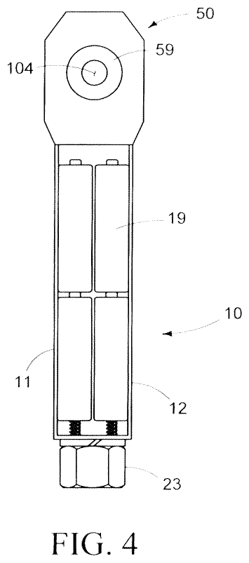

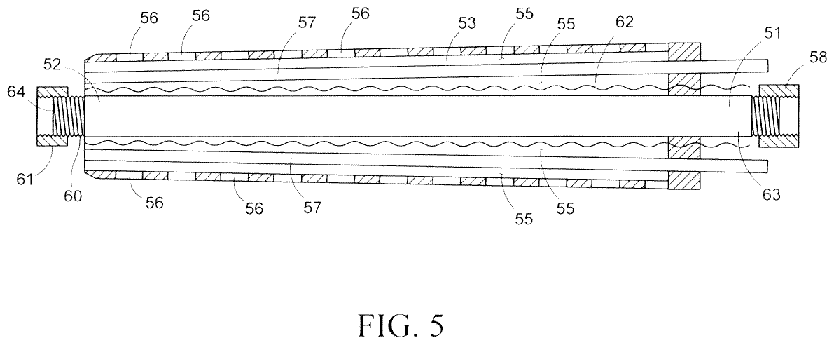

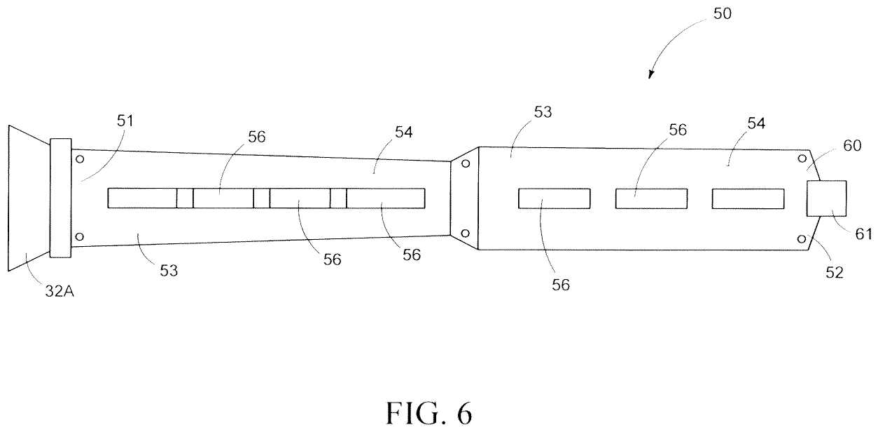

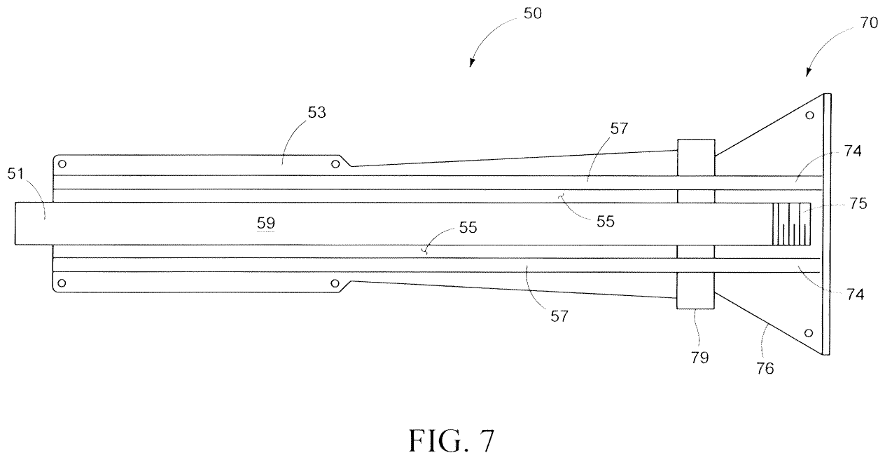

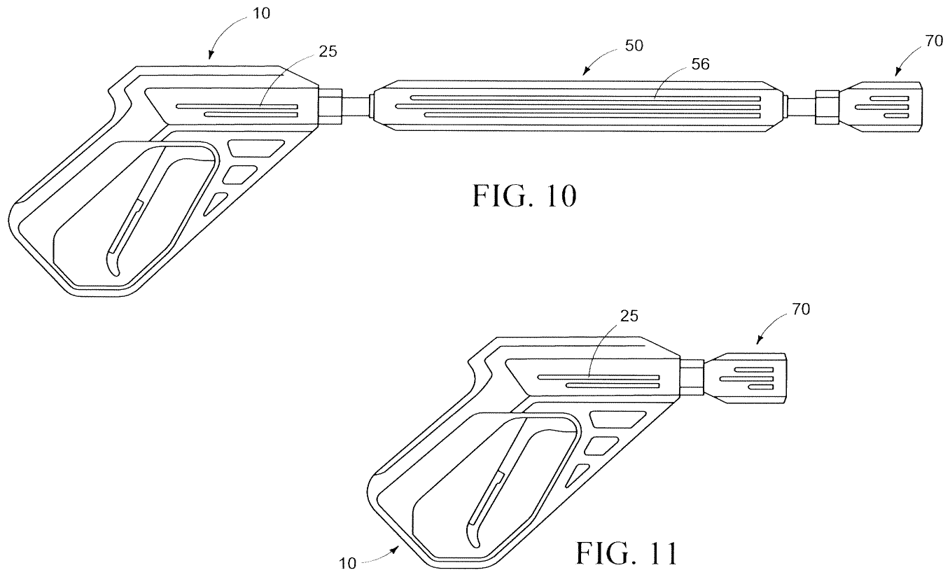

As shown in FIG. 1, the lance 50 has a lance housing 53 and is preferably elongated having a first end portion 51 and a spaced apart second end portion 52. The lance housing 53 has an exterior surface 54 and defines an interior channel 55. The lance housing 53 defines a plurality of spacedly arrayed openings 56 that communicate between the exterior surface 54 and the interior channel 55. The plurality of spacedly arrayed openings 56 may have a variety of geometric configurations. (See FIGS. 2, 5, 6, 10). A mirrored light tube/refractor 57 may be carried within the interior channel 55 so as to reflect and refract illumination generated by the plurality of emitters 31, 74 of visible EMR. Lengths of fiber-optic cable/fiber/LED light strip may be carried within the interior channel 55. Conductors, such as, but not limited to electrical wires 62 may be carried within the lance housing 53 to provide electrical energy to the plurality of emitters 31, 74 of visible EMR, and the electrical wires 62 operatively communicate with the power source 19 in the handle 10, the control board 18 and the emitter switch 26. The electrical wires 62 may also operatively communicate with the nozzle 70.

A pressurized fluid tube 59 is carried within the lance housing 53 extending from the first end portion 51 to the second end portion 52. The pressurized fluid tube 59 carries a releasable connection fitting 58 at a first end portion 63 for engagement with the releasable connection 34 at the second end portion 30 of the second fluid conduit 28. The pressurized fluid tube 59 also carries a releasable connection fitting 61, at a second end portion 64 which may releasably connect with the nozzle 70. The pressurized fluid tube 59 defines an interior medial channel (not shown) to allow pressurized fluid to pass therethrough. The lance 50 is releasably interconnectable to the handle 10. The releasable connection fitting 58 may be a threaded connection to connect with the second end portion 30 of the second fluid conduit 28 so that pressurized fluid flowing through the second fluid conduit 28 is communicated through the pressurized fluid tube 59 and simultaneously through the lance 50. Similar to the handle 10, the plurality of emitters 31, 74 of visible EMR (LED's, LED light strip, fiber-optic fibers, light tubes, lasers, spotlights) carried within the lance 50, when energized, emit visible electromagnetic radiation that shines outwardly through the plurality of spacedly arrayed openings 56 defined in the lance 50 to provide aesthetic appeal. The interconnection of the lance 50 to the handle 10 changes the exterior configuration of the spray gun and enhances the visual appeal as well as allowing a user to pressure wash more recessed locations on an object being washed. The interconnection of the lance 50 to the handle 10 also facilitates two hand use of my invention by a user. Two-hand retention/handling of the invention by a user may be necessary/advisable when the pump supplies higher pressures to the fluid.

The nozzle 70 is releasably attachable to the second end portion 64 of the pressurized fluid tube 59 and the releasable connection fitting 61 carried thereat.

In an even still further contemplated embodiment, a protective rubber cone 76 may be carried on an exterior surface 79 of the nozzle 70 to provide durability and to protect the nozzle 70. The protective rubber cone 76 may have an outer peripheral configuration other than cone shaped, such as, but not limited to, a square, a rectangle, a pipe, a barrel, etc.) to change the exterior configuration/appearance of the nozzle 70, while maintaining the internal conical configuration.

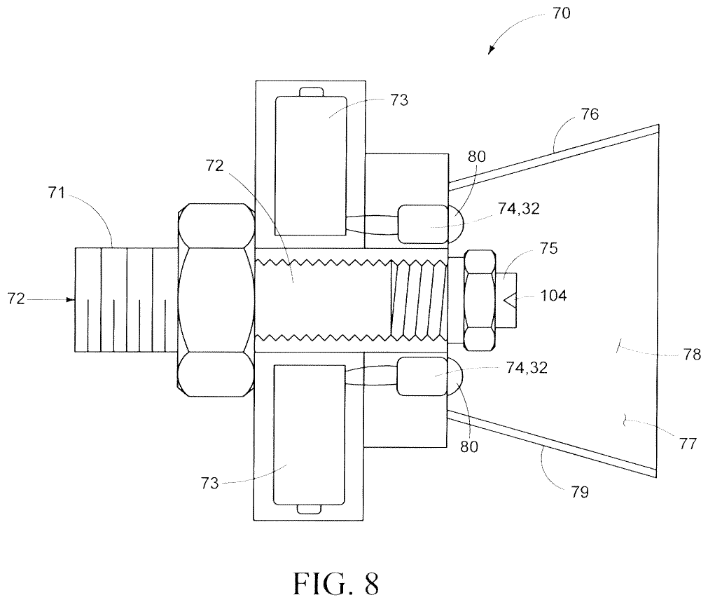

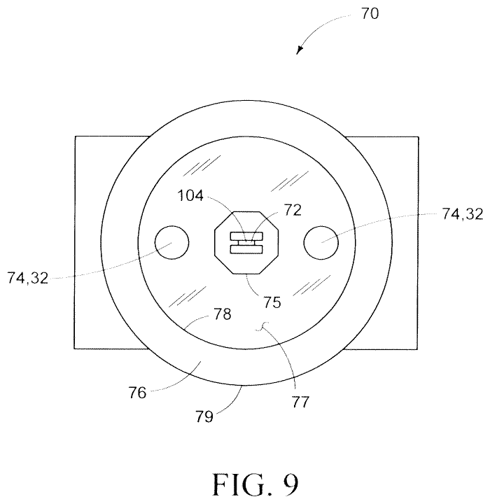

The spray tip 75 defining the fluid exit orifice 104, may have a variety of configurations designed to “configure” the shape and/or angle and/or density of the stream of pressurized fluid exiting the fluid exit orifice 104. Such a shape and/or angle and/or density may be, for example only but not limited to, a pencil stream, a cone, a wedge, a mist, or even pulses. Such configurations of spray streams may provide a variety of different purposes such as, but not limited to cleaning, blasting, or maximizing surface area. In a contemplated embodiment, a plurality of LEDs 74, or other emitters of visible EMR, are carried by the nozzle 70 and are spacedly arrayed about the spray tip 75 within the medial chamber 77 so that the plurality of LEDs 74 (emitters) are nearly immediately adjacent the stream of pressurized fluid exiting the fluid exit orifice 104. In a further preferred embodiment, a prism or lens 80 may be carried by, adjacent to, or even within the nozzle 70 to focus and/or concentrate and/or reflect and/or refract light waves generated by the LEDs 74 (emitters) onto the stream of pressurized fluid exiting the fluid exit orifice 104. As shown in FIG. 8, the nozzle 70 may have its own power source 73.

Water has a refractive index of approximately 1.33 at 20 degrees Celsius. Therefore, when water is exposed to a light source, such as the plurality of emitters 31, 74 of visible EMR including, but not limited to LED's, LED light strips, fiber-optics, light tubes, lasers, spotlights, and the like, the colorful illumination generated/transmitted/passed thereby Is communicated to the water and is thereafter “carried by” the water as the pressurized stream of water is dispersed/dispensed. The result is that the electromagnetic illumination generated by the plurality of emitters 31, 74 of visible EMR is carried along with the pressurized water as the pressurized water travels outwardly from the fluid exit orifice 104 of the spray tip 75. The illuminated pressurized stream of water can carry a variety of colors, and even change colors over time, such as with a rotating color wheel/lens. The provision of color to the fluid/water being dispensed through the spray tip 75 provides an aesthetic appeal and novelty to the otherwise mundane process of pressure washing a surface, such as a dirty vehicle.

In an even still further contemplated embodiment, sound/audio may be generated 121 and emitted by my invention in combination with, and in synchrony with, the light sequences such as, but not limited to, creating an audio sound of the laser cannon pulse each time the light sequence reaches the nozzle 70/fluid exit orifice 104. In an even still further contemplated embodiment, my invention may further include a haptic feedback generator 120, such as, but not limited to an eccentric rotating mass, or a linear resonant actuator that may be carried within the handle 10. The haptic feedback generator 120 would actuate in synchrony with the programmed light sequences, and perhaps even the audio/sound sequences to still further enhance the visual, audio and tactical appeal of my invention.

Having described the structure of my illuminated pressure wash gun with illuminated spray, its operation may be understood.

A source of fluid (not shown) and a source (not shown) for pressurizing the fluid are provided.

A flexible pressurized fluid hose 111 is interconnected to the source of pressurized fluid (not shown). An end portion of the flexible pressurized fluid hose 111, opposite the source of pressurized fluid (not shown) is interconnected to the hose fitting 23 of the handle 10.

A source of electrical energy is provided, such as, but not limited to a battery/batteries 19 are installed within the interior chamber 16 of the handle 10. If a lance 50 is to be installed upon the handle 10, any spray tip 75 already carried at the second end portion 30 of the second fluid conduit 28 of the handle 10 is removed by operating the releasable connection 34.

The lance 50 is aligned with the handle 10 so that the first end portion 51 of the lance 50 may be interconnected with the releasable connection 34 carried at the second end portion 30 of the second fluid conduit 28. Electrical connections between the handle 10 body 11 and the lance 50 are also interconnected. The nozzle 70 is interconnected with the lance 50, at the second end portion 52 thereof. Any adjustments necessary for the spray tip 75 so as to adjust the desired configuration of the spray stream are made to the spray tip 75 carried by/within the nozzle 70. If a power source 19 is carried within the nozzle 70 (FIG. 8) the power source 19 is installed.

The source of pressurized fluid (not shown) is energized so that a continuous supply of pressurized fluid is supplied to the handle 10, through the flexible pressurized fluid hose 111.

The pressurized fluid does not flow through the handle 10, and through the second fluid conduit 28 carried therein unless and until the pressure valve 27 is actuated by a user drawing/pulling the trigger 17 into closer proximity with the hand grip portion 13 of the handle 10. When the user draws the trigger 17 into proximity with the hand grip portion 13, the trigger 17 operatively actuates the pressure valve 27 allowing the pressurized fluid received from the pressurized fluid source (not shown) to pass through the first fluid conduit 20 from the first end portion 21 to the second end portion 22, and thereafter through the actuated pressure valve 27, and thereafter through the second fluid conduit 28 from the first end portion 29 to the second end portion 30. Thereafter the pressurized fluid passes into the pressurized fluid tube 59 carried within the lance 50 passing from the first end portion 51 to the second end portion 52. Thereafter, the pressurized fluid passes into and through the nozzle 70 and the spray tip 75 carried thereby. The pressurized fluid is dispersed through the fluid exit orifice 104 of the nozzle 70 in the desired configuration as previously determined/set by the user via adjustments to the spray tip 75.

Concurrent with actuation of the pressure valve 27 responsive to movement of the trigger 17, the emitter trigger switch 26 is actuated responsive to movement of the trigger 17. The emitter trigger switch 26 facilitates passage of electrical energy from the power source/battery 19, through the wires 33 and to and from the control board 18 to the plurality of emitters 31, 74 of visible EMR spacedly arrayed about the handle 10, the lance 50 and the nozzle 70. When the plurality of emitters 31, 74 of visible EMR are illuminated to emit visible electromagnetic radiation (EMR), the emitted visible electromagnetic radiation (EMR) is shined upon the stream of pressurized fluid/water being dispersed through the spray tip 75, and is also emitted through the plurality of spacedly arrayed openings 25, 56, defined in the handle 10, the lance 50 and about the interior surface 78 of the nozzle 70. The plurality of spacedly arrayed prisms (not shown) and/or plurality of spacedly arrayed lenses (not shown) and the reflective coating on the interior surface 78 of the nozzle 70 concentrate the emitted visible EMR onto the emitted/dispersed stream of pressurized fluid/water which causes the stream of pressurized fluid/water to be illuminated casting a colorful and fanciful display. A rotating color wheel (not shown) that may be carried within the handle 10, or otherwise, may change/alter the color of the visible EMR as it passes though and out of the fiber optic cables and light tubes and/or LED's and/or LED light strips.

A principal object of the present invention is an apparatus for dispersing pressurized fluid received from a pressurized fluid source, the apparatus comprising: a handle (10) having a hand grip portion (13), a trigger guard (15) spacedly adjacent the hand grip portion (13) and a movable trigger (17) between the hand grip portion (13) and a trigger guard (15); a power source (19); an emitter trigger switch (26) carried within the handle (10) and operably communicating with the trigger (17); a fluid conduit (20, 28) carried within the handle (10); a pressure valve (27) carried within the handle (10) and operatively communicating with the fluid conduit (20, 28), with the trigger (17) and with the pressurized fluid source; a nozzle (70) defining a fluid exit orifice (104) carried by the handle (10) and operatively communicating with the fluid conduit (20, 28); and an emitter of visible electromagnetic radiation (31, 74) operatively communicating with the power source (19) and with the emitter trigger switch (26), and the emitter of visible electromagnetic radiation (31, 74) illuminates the pressurized fluid dispersed through the fluid exit orifice (104) defined in the nozzle (70).

A further object of the present invention is an apparatus for dispensing pressurized fluid and further comprising: a control board (18) that operatively communicates with the power source (19), with the emitter trigger switch (26), and with the emitter of visible electromagnetic radiation (31, 74).

A further object of the present invention is an apparatus for dispensing pressurized fluid and further comprising: a plurality of spacedly arrayed openings (25) defined in the handle (10); and a plurality of emitters of visible electromagnetic radiation (31, 74) carried within the handle (10),

A further object of the present invention is an apparatus for dispensing pressurized fluid and further comprising: an emitter of visible electromagnetic radiation (31, 74) carried by the nozzle (70) and proximate to the fluid exit orifice (104) to illuminate the dispersed pressurized fluid.

A further object of the present invention is an apparatus for dispensing pressurized fluid and further comprising: a lance (50) having a first end portion (51) that engages with the handle (10), and a second end portion (52) that engages with the nozzle (70); and the lance (50) having a housing (53) that has an exterior surface (54) that defines plural spacedly arrayed openings (56) and the lance (50) defines an interior channel (55) extending between the first end portion (51) and the second end portion (52); and a pressurized fluid tube (59) is carried in the interior channel (55), and the pressurized fluid tube (59) communicates with the fluid conduit (20, 28) in the handle (10) and with the nozzle (70); and plural emitters of visible electromagnetic radiation (31, 74) are carried within the interior channel (55) and the plural emitters of visible electromagnetic radiation (31, 74) operatively communicate with the power source (19) and with the emitter trigger switch (26).

A further object of the present invention is an apparatus for dispensing pressurized fluid wherein the control board (18) is programmed to cause the emitter of visible electromagnetic radiation (31, 74) to illuminate and de-illuminate in a predetermined sequence.

A further object of the present invention is an apparatus for dispensing pressurized fluid and further comprising: a sound/audio generator (121) that operatively communicates with the control board (18) and with the power source (19) to generate and emit a predetermined audio signal/sound in synchrony with the predetermined sequence of illumination/de-illumination of the plurality of emitters (31, 74) of visible electromagnetic radiation.

A further object of the present invention is an apparatus for dispensing pressurized fluid and further comprising: a haptic feedback generator (120) that operatively communicates with the control board (18) and with the power source (19) to generate and emit a predetermined haptic feedback in synchrony with the predetermined sequence of illumination/de-illumination of the plurality of emitters (31, 74) of visible electromagnetic radiation.

A further object of the present invention is an apparatus for dispensing pressurized fluid and wherein the plurality of emitters (31, 74) of visible electromagnetic radiation are LEDs, or are LED light strips, or are light tubes, or are fiber optics, or are spotlights, or are lasers,

A further object of the present invention is an apparatus for dispensing pressurized fluid and further comprising: a mirrored/reflective coating on an interior surface of the nozzle (70) proximate the fluid discharge orifice (104).

A further object of the present invention is an apparatus for dispensing pressurized fluid and further comprising: a mirrored/reflective coating on an interior surface of the interior channel (53) of the lance (50).

A further object of the present invention is an apparatus for dispensing pressurized fluid and further comprising: a mirrored/reflective coating on an interior surface of the handle (10).

A still further object of the present invention is a method for illuminating a stream of dispersed pressurized fluid, comprising the steps: providing a source of pressurized fluid; and providing a pressurized fluid tube (111) that communicates with the source of pressurized fluid; and providing a handle (10) and connecting the handle (10) to the pressurized fluid tube (111), the handle (10) having a hand grip portion (13), a trigger guard (15) spacedly adjacent the hand grip portion (13) and a movable trigger (17) between the hand grip portion (13) and a trigger guard (15); and providing a power source (19) and connecting the power source (19) to the handle (10); and providing an emitter trigger switch (26) within the handle (10) and operatively communicating with the trigger (17); and providing a fluid conduit (20, 28) within the handle (10); and providing a pressure valve (27) within the handle (10) and the pressure valve (27) operatively communicates with the fluid conduit (20, 28), with the trigger (17) and with the source of pressurized fluid; and providing a nozzle (70) that defines a fluid exit orifice (104) and connecting the nozzle 70 with the fluid conduit (20, 28); and providing an emitter of visible electromagnetic radiation (31, 74) that operatively communicates with the power source (19) and with the emitter trigger switch (26), and the emitter of visible electromagnetic radiation (31, 74) to illuminate the pressurized fluid dispersed through the fluid exit orifice (104) defined in the nozzle (70) when a user deflects the trigger (17); and providing a control board (18) within the handle (10) that operatively communicates with the power source (19) and with the emitter triggers switch (26), and wherein the control board (18) is programmable to cause the emitter (31, 74) of visible electromagnetic radiation to illuminate and de-illuminate in a predetermined sequence.

An even still further object of the present invention is a method for illuminating a stream of dispersed pressurized fluid, and further comprising the step: providing an elongated lance (50) that has a first end portion (51) and a spaced apart second end portion (52); and attaching the first end portion (51) of the lance (50) to the handle (10); and attaching the nozzle (70) to the second end portion (52) of the lance (50).

The foregoing description of my invention is necessarily of a detailed nature so that a specific embodiment of a best mode may be set forth as is required, but it is to be understood that various modifications of details, sizes, and rearrangement, substitution and multiplication of the parts may be resorted to without departing from its spirit, essence, or scope.

Having thusly described my invention, I file this Utility Patent Application, and respectfully request issuance of utility letters patent.

I claim:

1. An apparatus for dispersing pressurized fluid received from a pressurized fluid source, the apparatus comprising:
a handle (10) having a hand grip portion (13), a trigger guard (15) spacedly adjacent the hand grip portion (13) and a movable trigger (17) between the hand grip portion (13) and a trigger guard (15);
a power source (19);
an emitter trigger switch (26) carried within the handle (10) and operably communicating with the trigger (17);
a fluid conduit (20, 28) carried within the handle (10);
a pressure valve (27) carried within the handle (10) and operatively communicating with the fluid conduit (20, 28), with the trigger (17) and with the pressurized fluid source;
a nozzle (70) defining a fluid exit orifice (104) carried by the handle (10) and operatively communicating with the fluid conduit (20, 28); and
an emitter of visible electromagnetic radiation (31, 74) operatively communicating with the power source (19) and with the emitter trigger switch (26), and the emitter of visible electromagnetic radiation (31, 74) illuminates the pressurized fluid dispersed through the fluid exit orifice (104) defined in the nozzle (70).

2. The apparatus of claim 1, and further comprising:
a control board (18) that operatively communicates with the power source (19), with the emitter trigger switch (26), and with the emitter of visible electromagnetic radiation (31, 74).

3. The apparatus of claim 1, and further comprising:
a plurality of spacedly arrayed openings (25) defined in the handle (10); and
a plurality of emitters of visible electromagnetic radiation (31, 74) carried within the handle (10).

4. The apparatus of claim 1, and further comprising:
an emitter of visible electromagnetic radiation (31, 74) carried by the nozzle (70) and proximate to the fluid exit orifice (104) to illuminate the dispersed pressurized fluid.

5. The apparatus of claim 1, and further comprising:
a lance (50) having a first end portion (51) that engages with the handle (10), and a second end portion (52) that engages with the nozzle (70); and
the lance (50) having a housing (53) that has an exterior surface (54) that defines plural spacedly arrayed openings (56) and the lance (50) defines an interior channel (55) extending between the first end portion (51) and the second end portion (52); and
a pressurized fluid tube (59) is carried in the interior channel (55), and the pressurized fluid tube (59) communicates with the fluid conduit (20, 28) in the handle (10) and with the nozzle (70); and
plural emitters of visible electromagnetic radiation (31, 74) are carried within the interior channel (55) and the plural emitters of visible electromagnetic radiation (31, 74) operatively communicate with the power source (19) and with the emitter trigger switch (26).

6. The apparatus of claim 2 wherein the control board (18) is programmed to cause the emitter of visible electromagnetic radiation (31, 74) to illuminate and de-illuminate in a predetermined sequence.

7. The apparatus of claim 6 and further comprising:
a sound/audio generator (121) that operatively communicates with the control board (18) and with the power source (19) to generate and emit a predetermined audio signal/sound in synchrony with the predetermined sequence of illumination/de-illumination of the plurality of emitters (31, 74) of visible electromagnetic radiation.

8. The apparatus of claim 6 and further comprising:
a haptic feedback generator (120) that operatively communicates with the control board (18) and with the power source (19) to generate and emit a predetermined haptic feedback in synchrony with the predetermined sequence of illumination/de-illumination of the plurality of emitters (31, 74) of visible electromagnetic radiation.

9. The apparatus of claim 1, wherein the plurality of emitters (31, 74) of visible electromagnetic radiation are LEDs.

10. The apparatus of claim 1, wherein the plurality of emitters (31, 74) of visible electromagnetic radiation are LED light strips.

11. The apparatus of claim 1, wherein the plurality of emitters (31, 74) of visible electromagnetic radiation are light tubes.

12. The apparatus of claim 1, wherein the plurality of emitters (31, 74) of visible electromagnetic radiation are fiber-optics.

13. The apparatus of claim 1, wherein the plurality of emitters (31, 74) of visible electromagnetic radiation are spotlights,

14. The apparatus of claim 1, and further comprising:
a mirrored/reflective coating on an interior surface of the nozzle (70) proximate the fluid discharge orifice (104).

15. The apparatus of claim 1, and further comprising:
a mirrored/reflective coating on an interior surface of the interior channel (53) of the lance (50).

16. The apparatus of claim 1, and further comprising:
a mirrored/reflective coating on an interior surface of the handle (10).

17. A method for illuminating a stream of dispersed pressurized fluid, comprising the steps:
providing a source of pressurized fluid; and
providing a pressurized fluid tube (111) that communicates with the source of pressurized fluid; and
providing a handle (10) and connecting the handle (10) to the pressurized fluid tube (111), the handle (10) having a hand grip portion (13), a trigger guard (15) spacedly adjacent the hand grip portion (13) and a movable trigger (17) between the hand grip portion (13) and a trigger guard (15); and
providing a power source (19) and connecting the power source (19) to the handle (10); and
providing an emitter trigger switch (26) within the handle (10) and operatively communicating with the trigger (17); and
providing a fluid conduit (20, 28) within the handle (10); and
providing a pressure valve (27) within the handle (10) and the pressure valve (27) operatively communicates with the fluid conduit (20, 28), with the trigger (17) and with the source of pressurized fluid; and
providing a nozzle (70) that defines a fluid exit orifice (104) and connecting the nozzle 70 with the fluid conduit (20, 28); and
providing an emitter of visible electromagnetic radiation (31, 74) that operatively communicates with the power source (19) and with the emitter trigger switch (26), and the emitter of visible electromagnetic radiation (31, 74) to illuminate the pressurized fluid dispersed through the fluid exit orifice (104) defined in the nozzle (70) when a user deflects the trigger (17); and
providing a control board (18) within the handle (10) that operatively communicates with the power source (19) and with the emitter triggers switch (26), and wherein the control board (18) is programmable to cause the emitter (31, 74) of visible electromagnetic radiation to illuminate and de-illuminate in a predetermined sequence.

18. The method for illuminating a stream of dispersed pressurized fluid of claim 17, and further comprising the step:
providing an elongated lance (50) that has a first end portion (51) and a spaced apart second end portion (52); and
attaching the first end portion (51) of the lance (50) to the handle (10); and
attaching the nozzle (70) to the second end portion (52) of the lance (50).
